(19) United States
(12) Patent Application Publication
(10) Pub. No.: US 2010/0131576 A1
(43) Pub. Date: May 27, 2010

(54) INFORMATION REPRODUCTION METHOD AND INFORMATION REPRODUCTION APPARATUS

(76) Inventors: Katsumi Akagi, Osaka (JP); Tetsuhiro Kohada, Hyogo (JP); Hiroyuki Nishino, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/596,720

(22) PCT Filed: Apr. 10, 2008
(86) PCT No.: PCT/JP2008/000946

§ 371 Date: Oct. 20, 2009

(30) Foreign Application Priority Data
Apr. 25, 2007 (JP) 2007-115196

(51) Int. Cl. G06F 17/30

(52) U.S. Cl. 707/822; 707/831; 707/E17.01

(57) ABSTRACT

Provided is a storage medium on which data is recorded under the industry organization standard, or the format standard complying with the global standard, and a directory and a file can be reproduced from the storage medium based on a virtual root directory, in the method complying with the format standard even though directory management information is broken, by reading data recorded on a disk and setting the highest-order directory in a directory structure, obtained by collecting and analyzing the directory management information, as the virtual root directory.

### TECHNICAL FIELD

The present invention relates to an information reproduction method and an information reproduction apparatus for reproducing data recorded on a disk medium, and more specifically to an information reproduction method and an information reproduction apparatus for reproducing data having a broken directory structure.

### BACKGROUND ART

Data is recorded on a disk media for a variety of uses such as for use in a PC (Personal Computer) and for use in an AV (Audio and Visual). In such a case, a logical file system is generally used, and in the logical file system, recorded data is managed as files and a directory hierarchy is built. Examples of the logical file systems include a widespread FAT system, a UDF (Universal Disk Format) introduced into a DVD and the like. A storage medium such as a disk medium and a memory card on which data is recorded under the industry organization standard, the format standard complying with the global standard, the UDF standard and the like, can be reproduced in a method complying with the format standard concerned.

FIG. 11 illustrates an information reproduction apparatus 900 of a conventional art. In FIG. 11, the information reproduction apparatus 900 includes a control section 10, a data read section 11, and a display section 12. The data read section 11 reads data recorded on a disk medium 20. The control section 10 reproduces data read by the data read section 11 based on a reproduction method complying with a format standard. The display section 13 displays a directory and a file reproduced by the control section 10.

Here, the directory structure in the logical file system will be described in detail. FIG. 12 illustrates the directory hierarchy. As illustrated in FIG. 12, data recorded on the disk medium is managed as a file in each hierarchy in which directories are built. FIG. 13 illustrates the directory structure in the logical file system. In FIG. 13, by using logical addresses indicated by pointers of a File Entry (FE) and a File Identifier Descriptor (FID), each directory hierarchy is built in the logical file system.

For example, a case of an access to a file 111 will be described. Initially, an FE of a root directory 0 is referenced. The FE of the root directory 0 includes FIDS of directories 1 and 2, and a file 3. Based on the FID of the directory 1, an FE of the directory 1 under the root directory 0 is referenced. The FE of the directory 1 includes FIDS of a directory 11, and files 12 and 13. Based on the FID of the directory 11, an FE of the directory 11 under the directory 1 is referenced. The FE of the directory 11 includes FIDS of the file 111 and a file 112. Based on the FID of the file 111, an FE of the file 111 under the directory 11 is referenced. Based on the FE of the file 111, data of the file 111 can be accessed.

As described above, in the logical file system such as the UDF, except the root directory, the FID, the FE, and actual data are accessed in order, respectively, by using the FID and the FE as pointers.

In addition, there is an apparatus using management information (directory management information) related to the directory structure complying with the format standard for the above-described logical file system (e.g., see Patent Document 1). This is the apparatus which makes any directory look like the root directory for a user in order to visually display only any directories, which correspond to the processing apparatus concerned, in the directory structure recorded on the disk medium.

### Patent Document 1: Japanese Laid-Open Patent Publication No. 2005-182122

### DISCLOSURE OF THE INVENTION

### Problems to be Solved by the Invention

However, when directory management information is broken for some reasons, a part of or all of directories and files become unable to be reproduced in the method complying with the format standard. For example, as to a video camera using a disk medium, which has been widespread in recent years, it may be considered that the recording surface is damaged due to the careless dropping. In this case, when directory management information of a directory including a video data file is broken, even though filmed video data fully remains, the video data file becomes unable to be read, so that video images cannot be reproduced at all. In this manner, when the directory management information is broken, a file may not be reproduced even though recorded data remains.

Specifically, when a directory structure is damaged, even though data recorded on a disk medium remains, the data is not displayed on the display section 13. FIG. 14 illustrates a state of the directory structure which is partially damaged. When the directory structure is damaged between the root directory 0 and the directory 1, the directory 11 and the files 12, 13, 111 and 112 under the directory 1 cannot be reproduced even though the data thereof remains in the disk medium. Similarly, when the directory structure around the directory 2 is damaged, a directory 22, and files 3, 21, 221 and 222 cannot be reproduced.

FIG. 15 illustrates the directory structure in the logical file system where the directory management information is broken. As illustrated in FIG. 13, when the file 111 is to be accessed, the FE of the root directory 0 is initially referenced. Here, since directory management information is broken, the FIDS included in the FE of the root directory 0 cannot be read, so that a directory and a file under the root directory 0 cannot be referenced. Accordingly, unlike the manner illustrated in FIG. 13, the file 111 cannot be sequentially accessed based on pointers of the FE and the FID. As a result, data of the file 111 cannot be reproduced even though the data remains in a disk medium as recorded data.

Therefore, an object of the present invention is to provide an information reproduction method that allows the recorded data remaining in the disk medium to be reproduced even though the directory management information is broken.

### Solution to the Problems

To achieve the above objects, the information reproduction method of the present invention for reproducing data which is recorded on an information storage medium based on a logical file system where a directory structure is constructed by using logical addresses and a storage location of the data is indicated based on a root directory executes: in the case where the recorded data becomes unable to be reproduced in a method based on the logical file system, a virtual root directory creation step of reading the recorded data by using a physical address, extracting, based on information related to the directory structure and included in the read data, every directory whose higher-order directory is not found, and setting all of the extracted directory as the root directory; and a reproduction step of reproducing, in the method based on the logical file system, a file under the virtual root directory based on the virtual root directory.

It is preferable that the virtual root directory creation step executes: a read-in-units step of reading data recorded on the information storage medium from which the recorded data has become unable to be reproduced in the method based on the logical file system, in units of a plurality of sectors as sector data; a directory structure determination step of determining whether or not a plurality of pieces of the sector data read in the read-in-units step are information related to the directory structure; a directory location determination step of determining a hierarchy and positional relation of a directory among directories based on at least one piece of the sector data which is determined in the directory structure determination step as the information related to the directory structure; and a virtual root directory allocation step of allocating, as the virtual root directory, the directory which is determined in the directory location determination step as the directory whose higher-order directory is not found.

It is further preferable that the information reproduction method further executes a reproduction start determination step of determining whether or not to perform the information reproduction method in accordance with an input by one of a user and settings.

To achieve the above object, the information reproduction apparatus of the present invention for reproducing data which is recorded on an information storage medium based on a logical file system where a directory structure is constructed by using logical addresses and a storage location of the data is indicated based on a root directory includes: a virtual root directory creation section for reading, in the case where the recorded data becomes unable to be reproduced in a method based on the logical file system, the recorded data by using a physical address, extracting, based on information related to the directory structure and included in the read data, every directory whose higher-order directory is not found, and setting all of the extracted directory as the root directory; and a reproduction section for reproducing, in the case where the recorded data becomes unable to be reproduced in a method based on the logical file system, a file under the virtual root directory based on the virtual root directory, in the method based on the logical file system.

It is preferable that the virtual root directory creation section includes: a read-in-units section for reading data recorded on the information storage medium from which the recorded data has become unable to be reproduced in the method based on the logical file system, in units of a plurality of sectors as sector data; a directory structure determination section for determining whether or not a plurality of pieces of the sector data read by the read-in-units section are information related to the directory structure; a directory location determination section for determining a hierarchy and positional relation of a directory among directories based on at least one piece of the sector data which is determined by the directory structure determination section as the information related to the directory structure; and a virtual root directory allocation section for allocating, as the virtual root directory, the directory, which is determined by the directory location determination section as the directory whose higher-order directory is not found.

It is further preferable that the information reproduction apparatus further includes a reproduction start determination section for determining whether or not to perform the information reproduction method in accordance with an input by one of a user and settings.

A series of information reproduction method, as described above, executed by the information reproduction apparatus may be provided as a program causing a computer to execute the process steps as described above. The program may be implemented in a computer in the form of being recorded on a computer-readable storage medium.

### EFFECT OF THE INVENTION

As described above, in the information reproduction method of the present invention, even when the directory management information recorded on the disk medium is broken due to an accident or a user's carelessness, and consequently a file cannot be reproduced in the method complying with the format standard, the remaining directories and the remaining files can be reproduced, based on a virtual root directory, in the method complying with the format standard, the virtual root directory being derived from the highest-order directory in a directory structure obtained by collecting and analyzing the directory management information.

In addition, in the information reproduction method of the present invention there is no need, for example, to preliminarily record additional information or the like aiming at protecting or restoring a directory and a file, because a directory and a file is reproduced in the method complying with the format standard. That is, the information reproduction method of the present invention is highly versatile because a directory and a file, which have become unable to be reproduced, becomes able to be reproduced without preparing a special apparatus or program in advance and without affecting an ordinary use of the medium at all.

### BRIEF DESCRIPTION OF THE DRAWINGS

FIG. 1 illustrates an information reproduction apparatus 100 for executing an information reproduction method according to an embodiment of the present invention.

FIG. 2 is a flowchart of the information reproduction method according to the embodiment of the present invention.

FIG. 3 is a block diagram illustrating an apparatus executing the information reproduction method of the present invention.

FIG. 4 illustrates a directory structure determination step S300 in detail.

FIG. 5 illustrates sector data stored in a buffer.

FIG. 6 illustrates a directory location determination step S400 in detail.

FIG. 7 illustrates a virtual root directory allocation step S500 in detail.

FIG. 8 illustrates a virtual root directory read step S600 in detail.

FIG. 9 illustrates a case where the directories 1 and 22 are set as the virtual root directories, and directories and files under the virtual root directories are reproduced.

FIG. 10 illustrates directories and files which are displayed based on the information reproduction method according to the present embodiment.

FIG. 11 illustrates an information reproduction apparatus 900 of a conventional art.

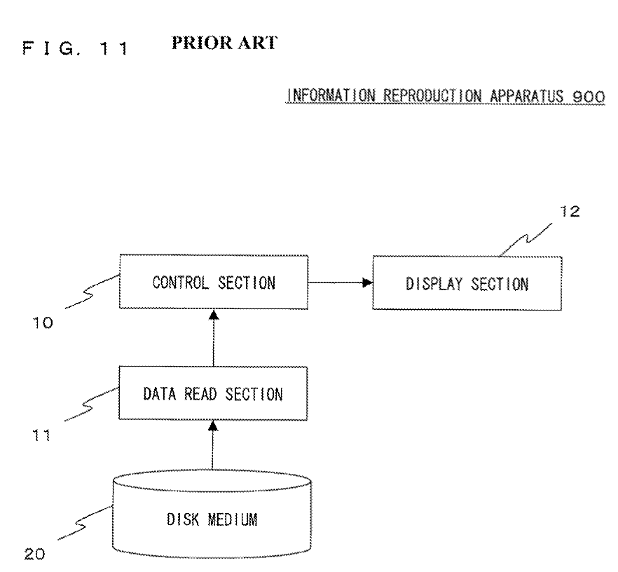

FIG. 12 illustrates a directory hierarchy.

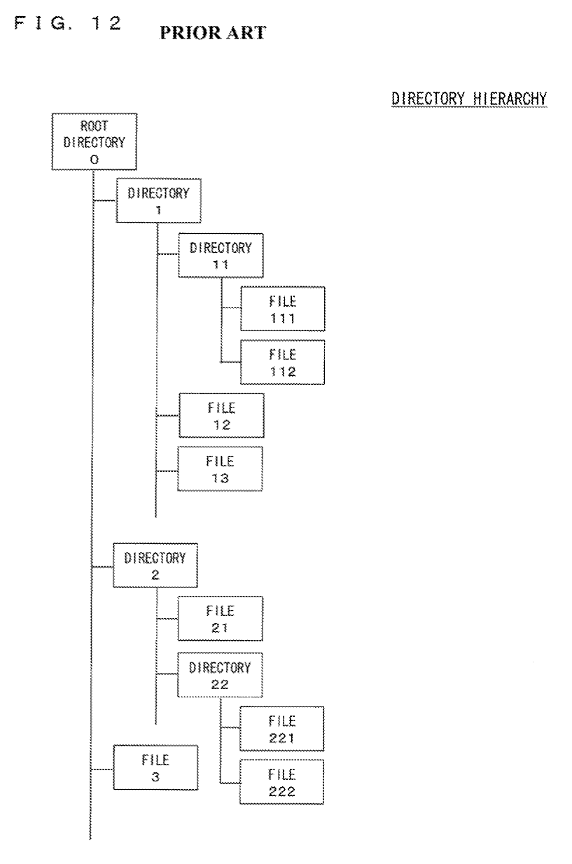

FIG. 13 illustrates a structure of a directory hierarchy in a logical file system.

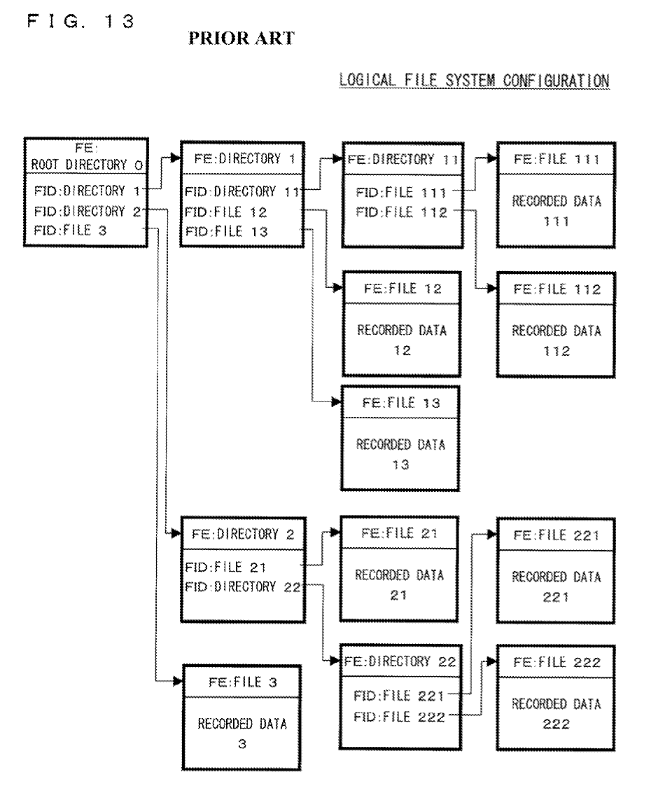

FIG. 14 illustrates a state where the directory structure is partially damaged.

FIG. 15 illustrates a structure of a directory hierarchy in a logical file system of a broken medium.

### DESCRIPTION OF THE REFERENCE CHARACTERS

10, 120 control section
11, 130 data read section
12, 140 display section
20 disk medium
100, 900 information reproduction apparatus
110 operation section
121 reproduction start determination section
122 virtual root directory creation section
123 reproduction section
1221 read-in-units section
1222 directory structure determination section
1223 directory location determination section
1224 virtual root directory allocation section
S100 reproduction start determination step
S101 virtual root directory creation step
S102 reproduction step
S200 read-in-units step
S201-S204 detailed steps of the read-in-units step
5300 directory structure determination step
S301-S305 detailed steps of the directory structure determination step
S400 directory location determination step
S401-S408 detailed steps of the directory location determination step
S500 virtual root directory allocation step
S501-S502 detailed steps of the virtual root directory allocation step
S600 virtual root directory read step
S601-S602 detailed steps of the virtual root directory read step

### BEST MODE FOR CARRYING OUT THE INVENTION

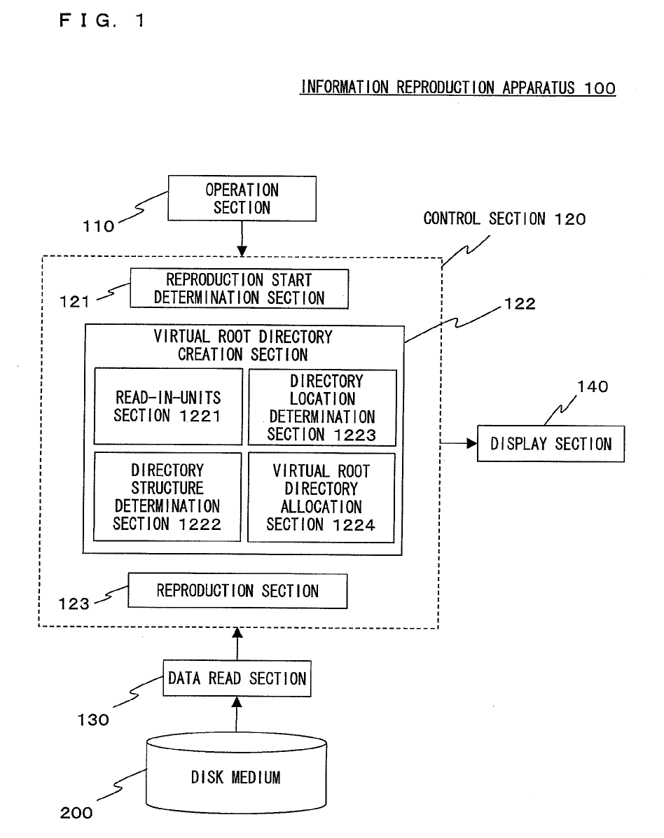

An embodiment of the present invention will be described below with reference to the drawings. FIG. 1 illustrates an information reproduction apparatus 100 for executing an information reproduction method according to the embodiment of the present invention. In FIG. 1, the information reproduction apparatus 100 includes an operation section 110, a control section 120, a data read section 130, and a display section 140. Further, the control section 120 includes a reproduction start determination section 121, a virtual root directory creation section 122, and a reproduction section 123. Still further, the virtual root directory creation section 122 includes a read-in-units section 1221, a directory structure determination section 1222, a directory location determination section 1223, and a virtual root directory allocation section 1224.

When the information reproduction apparatus 100 loads a disk medium 200, the data read section 130 reads data recorded on the disk medium 200. The control section 120 reproduces the data read by the data read section 130 by using the reproduction method complying with the format standard or the information reproduction method according to the present invention. The display section 140 displays a directory and a file reproduced by the control section 120.

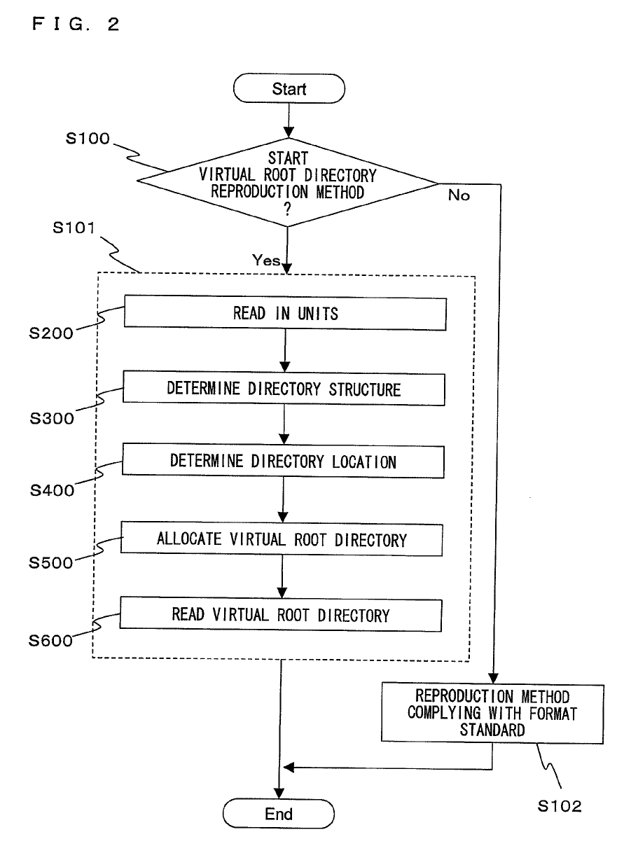

FIG. 2 is a flowchart of the information reproduction method according to the embodiment of the present invention. In the information reproduction method according to the embodiment of the present invention, a reproduction start determination step S100, a virtual root directory creation step S101, and a reproduction step S102 are performed.

In the reproduction start determination step S100, the reproduction start determination section 121 determines whether or not to start the information reproduction method according to the present invention. When directories and files recorded on the disk medium are reproduced, the directory management information is not usually damaged, and accordingly the reproduction section 123 reproduces data read by the data read section 130 by using a reproduction method complying with the format standard (step S102).

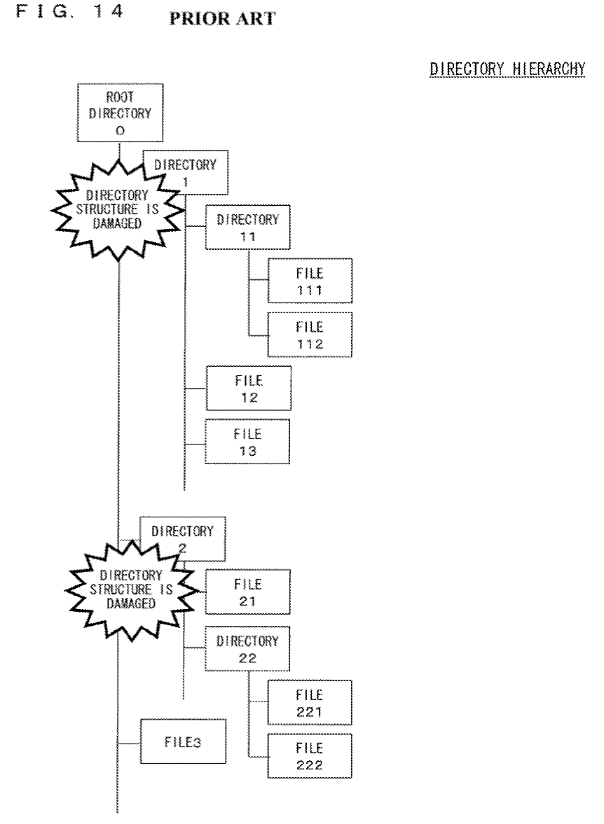

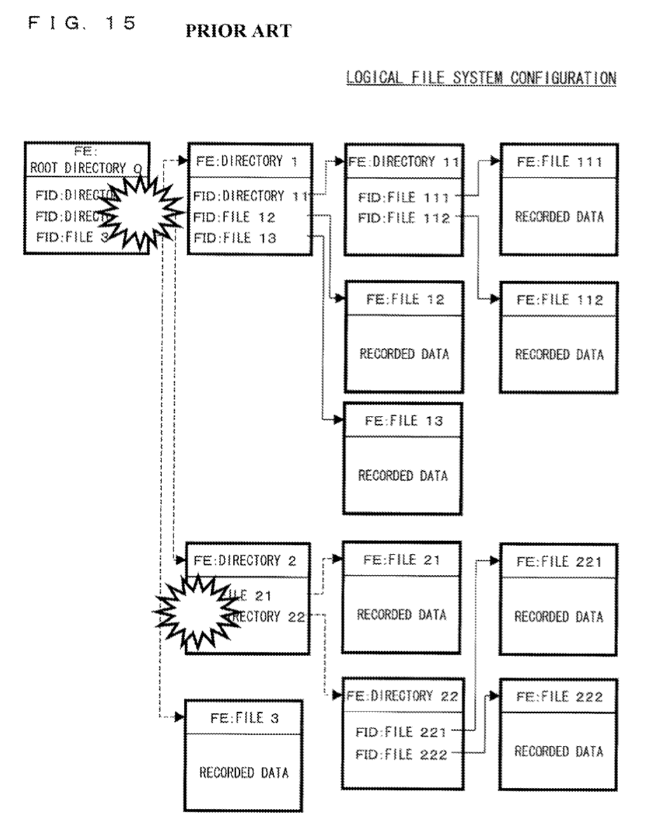

In the present embodiment, a method for reproducing remaining recorded data on the disk medium will be described when the directory structures of the root directory 0 and the directory 2 are damaged as illustrated in FIG. 14 and FIG. 15.

In the reproduction start determination step S100, since the directory management information is damaged as illustrated in FIG. 14 and FIG. 15, the reproduction start determination section 121 determines to start the information reproduction method according to the present invention (Yes in the reproduction start determination step S100). The control section 120 starts the information reproduction method according to the present invention for reproducing the remaining data in the disk medium. In addition, in the reproduction start determination step S100, when the information reproduction method according to the present invention is started, a user makes, at the operation section 110, an input for starting processing, but the start of the processing may not be necessarily performed by the user's operation. For example, when a directory and a file recorded on the disk medium cannot be reproduced by the reproduction method complying with the format standard due to the directory management information being damaged, an automatic start of the information reproduction method according to the present invention may be preset.

In the virtual root directory creation step S101, the virtual root directory creation section 122 sets as a virtual root directory a directory where directory structure is not damaged and reproduction is capable. In addition, the directory set as the virtual root directory is the directory that has no reproducible parent directory to which the directory belongs. Here, processing of the virtual root directory creation step S101 will be described in detail.

As illustrated in FIG. 2, in the virtual root directory creation step S101, a read-in-units step S200, a directory structure determination step S300, a directory location determination step S400, a virtual root directory allocation step S500, and a virtual root directory read step S600 are performed.

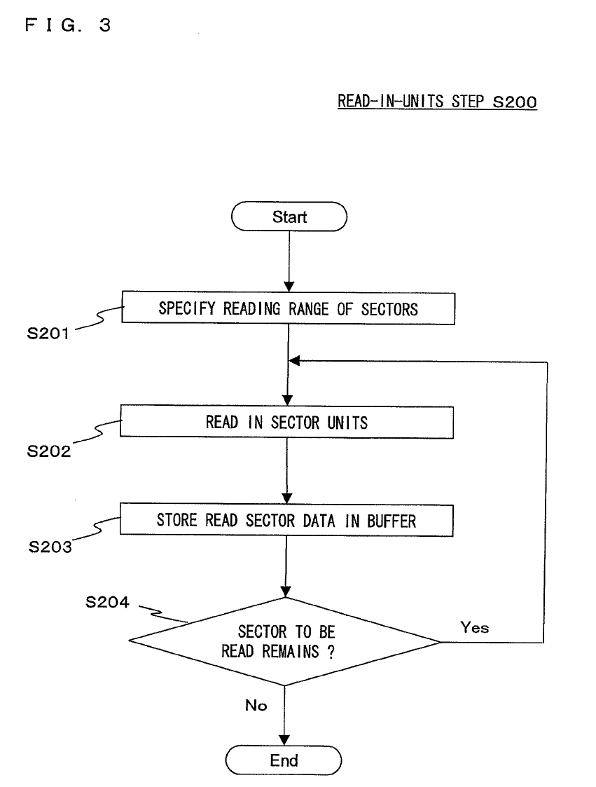

FIG. 3 illustrates the read-in-units step S200 in detail. In the read-in-units step S200, the read-in-units section 1221 sequentially reads all of the data recorded on the disk medium.

In step S201, the read-in-units section 1221 specifies a range of sectors in a sequential reading of all of the data recorded on the disk medium.

In step S202, the read-in-units section 1221 reads data (hereinafter, referred to as sector data), recorded on the disk medium, in sector units specified in step S201.

In step S203, the read-in-units section 1221 stores, in a buffer, the sector data read in step S202.

In step S204, the read-in-units section 1221 determines whether or not recorded data to be read from the disk medium remains. When the recorded data to be read remains in the disk medium (Yes in step S204), the processing returns to step S202. When the recorded data to be read does not remain in the disk medium (No in step S204), the process step of the read-in-units step S200 is terminated.

As described above, in the read-in-units step S200, the read-in-units section 1221 stores in a buffer all of the data, recorded on the disk medium, as sector data, in the specified sector units.

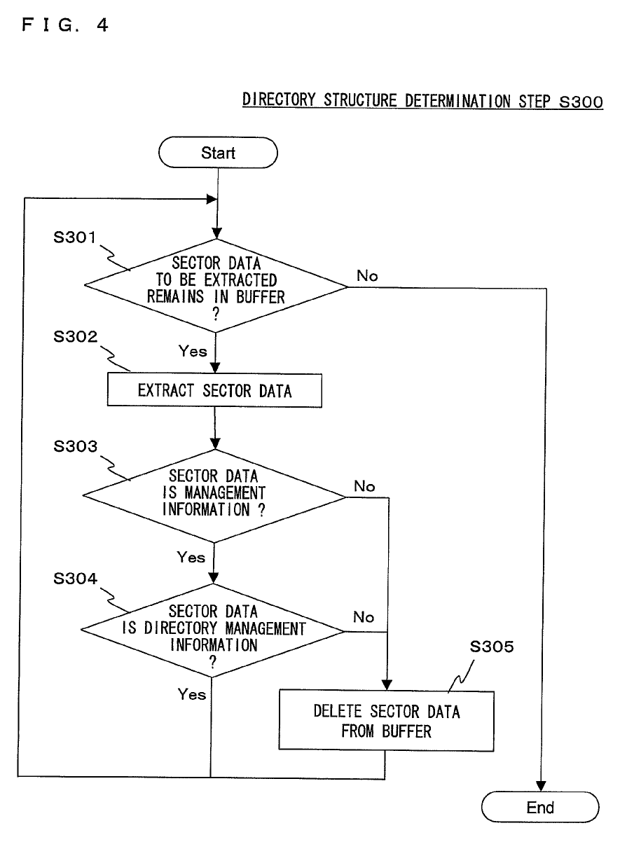

FIG. 4 illustrates the directory structure determination step S300 in detail. In the directory structure determination step S300, the directory structure determination section 1222 determines whether or not the sector data, which the read-in-units section 1221 has read in the read-in-units step S200, is directory management information.

In step S301, the directory structure determination section 1222 determines whether or not sector data to be extracted remains in the buffer. When sector data to be extracted does not remain in the buffer (No in step S301), the process step of the directory structure determination step S300 is terminated. When the sector data to be extracted remains in the buffer (Yes in step S301), a process step of step S302 described below is performed.

In step S302, the directory structure determination section 1222 sequentially extracts the sector data from the buffer.

In step S303, the directory structure determination section 1222 determines whether or not the sector data extracted in step S302 is management information. When the sector data is not the management information (No in step S303), the processing proceeds to step S305. Then, the directory structure determination section 1222 deletes the sector data from the buffer in step S305, and the processing returns to step S301. When the sector data is the management information (Yes in step S303), a process step of step S304 described below is performed.

In step S304, the directory structure determination section 1222 further determines whether or not the sector data, which has been determined as the management information in step S303, is directory management information. When the sector data is not the directory management information (No in step S304), the processing proceeds to step S305. In step S305, the directory structure determination section 1222 deletes the sector data, which is not determined as the directory management information, from the buffer, and the processing returns to step S301. When the sector data is the directory management information (Yes in step S304), the processing returns to step S301 and at that time the sector data concerned remains in the buffer.

In this manner, in the directory structure determination step S300, the directory structure determination section 1222 remains in the buffer only sector data that is the directory management information among sector data which the read-in-units section 1221 has stored in the buffer in the read-in-units step S200, and deletes other sector data from the buffer.

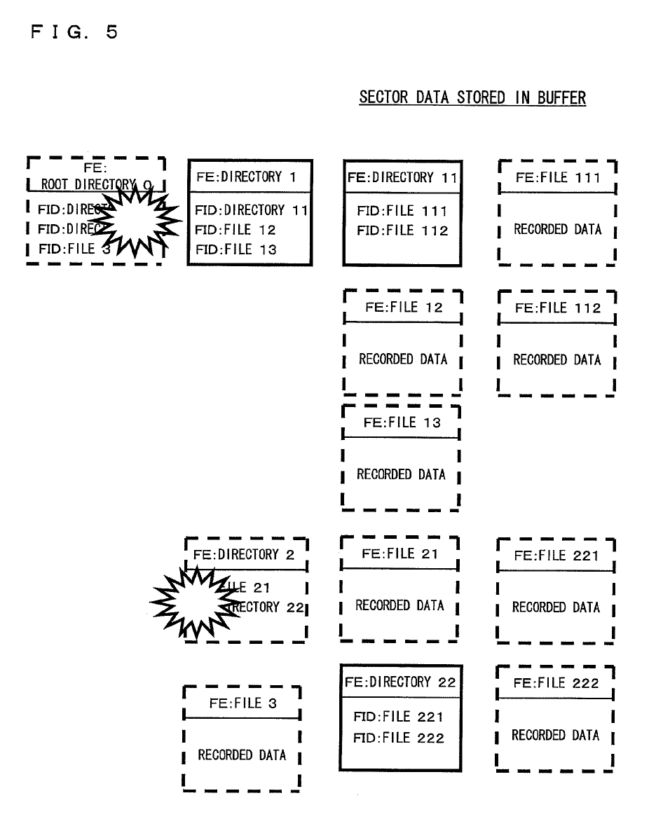

As described above, in the reproduction start determination step S100 through the directory structure determination step S300, only the directory management information is stored in the buffer as the sector data. In the following description, for reasons of clarity, the directory management information related to each of the directories and files illustrated in FIG. 15 is stored in the buffer as one piece of the sector data. However, the directory management information of the root directory 0 and directory 2 is not found due to destruction. FIG. 5 illustrates the sector data stored in the buffer. As described above three pieces of the sector data, directory 1, directory 11, and directory 22 are stored, here, as the sector data of the directory management information.

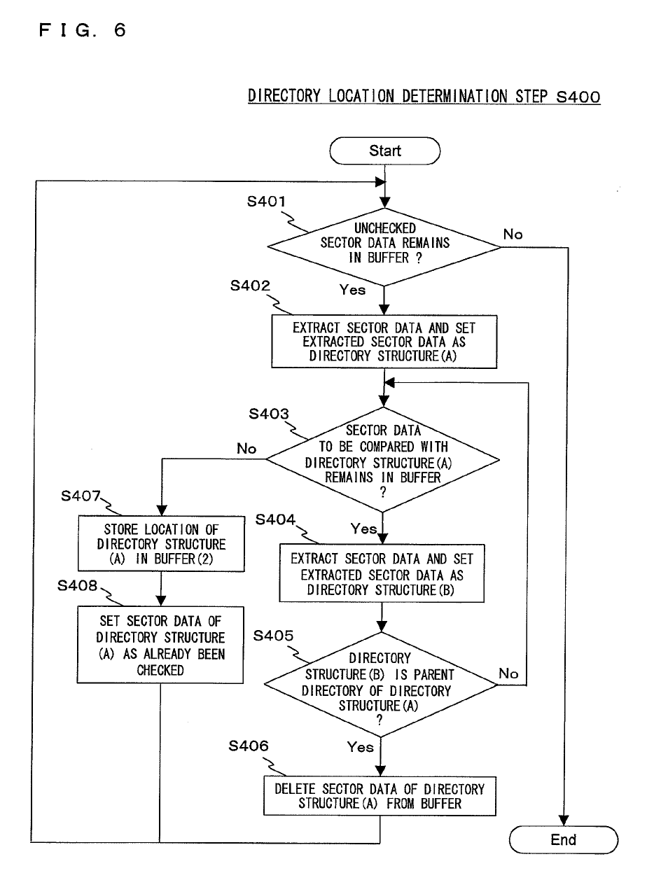

FIG. 6 illustrates the directory location determination step S400 in detail. In the directory location determination step S400, the directory location determination section 1223 determines the location of each directory based on the directory management information that the directory structure determination section 1222 has stored in the buffer in the directory structure determination step S300.

In step S401, the directory location determination section 1223 determines whether or not unchecked sector data remains in the buffer. When the unchecked sector data does not remain in the buffer (No in step S401), the process step of the directory location determination step S400 is terminated. When the unchecked sector data remains in the buffer (Yes in step S401), a process step of step S402 described below is performed.

In step S402, the directory location determination section 1223 extracts the unchecked sector data stored in the buffer, and sets the extracted sector data as a directory structure (A).

In step S403, the directory location determination section 1223 determines whether or not sector data to be compared with the directory structure (A) remains in the buffer. When sector data to be compared with the directory structure (A) does not remain in the buffer (No in step S403), the processing proceeds to step S407. In step S407, the directory location determination section 1223 stores the location of the directory structure (A) in another buffer (2). Then, in step S408, the directory location determination section 1223 sets the sector data of the directory structure (A) as being already checked, and the processing returns to step S401 so as to process other unchecked sector data. When sector data to be compared with the directory structure (A) remains in the buffer (Yes in step S403), a process step of step S404 described below is performed.

In step S404, the directory location determination section 1223 extracts sector data which is stored in the buffer and has not been compared with the directory structure (A), and sets the extracted sector data as a directory structure (B).

In step S405, the directory location determination section 1223 compares the directory structure (A) with the directory structure (B), and determines whether or not the directory structure (B) is a parent directory of the directory structure (A). When the directory structure (B) is not the parent directory of the directory structure (A) (No in step S405), the processing returns to step S403 so as to process other sector data that has not been compared with the directory structure (A). When the directory structure (B) is the parent directory of the directory structure (A) (Yes in step S405), a process step of step S406 described below is performed.

In step S406, the directory location determination section 1223 deletes the sector data of the directory structure (A) from the buffer, and the processing returns to step S401 so as to process other unchecked sector data.

As described above, in the directory location determination step S400, the directory location determination section 1223 determines the location of each directory based on the directory management information that the directory structure determination section 1222 has stored in the buffer in the directory structure determination step S300, and stores the directory structure that has no reproducible parent directory, as location data, in the other buffer (2).

Here, among the three pieces of sector data, which are the directory management information of the directories 1, 11 and 22 illustrated in FIG. 5, when, for example, the sector data of the directory 11 is set as the directory structure (A) initially (step S402), and the sector data of the directory 22 is set as the directory structure (B) (step S403, step S404), since the directory structure (B) is not determined as the parent directory of the directory structure (A) in step S405 (No in step S405), the processing returns to step S403. Next, when the sector data of the directory 1 is set as the directory structure (B) (step S403, step S404), since the directory structure (B) is determined as the parent directory of the directory structure (A) in step S405 (Yes in step S405), the processing proceeds to step S406. In step S406, the sector data of the directory 11 that is the directory structure (A) is deleted.

Next, when the sector data of the directory 1 is set as the directory structure (A) (step S402), the sector data of the directory 22 is set as the directory structure (B) (step S403, step S404). In step S405, since the directory structure (B) is not the parent directory of the directory structure (A) (No in step S405), the processing returns to step S403. Since sector data, which has not been compared with the directory structure (A), does not remain in the buffer in step S403 (No in step S403), the location of the directory structure (A) is stored in the other buffer (2) in step S407. Then, the sector data of the directory 1, which is the directory structure (A), is set in step S408 as already been checked.

Finally, when the sector data of the directory 22 is set as the directory structure (A) (step S402), the sector data of the directory 1 is set as the directory structure (B) (step S403, step S404). In step S405, since the directory structure (B) is not the parent directory of the directory structure (A) (No in step S405), the processing returns to step S403. Since sector data that has not been compared with the directory structure (A) does not remain in the buffer in step S403 (No in step S403), the location of the directory structure (A) is stored in the other buffer (2) in step S407. Then, in step S408, the sector data of the directory 22, which is the directory structure (A), is set as already been checked.

In this manner, the directory structures of the directories 1 and 22 are finally stored in the other buffer (2) as the location data depending on the sequential check of the sector data stored in the buffer. Note that, although in the present embodiment, directories 11, 1 and 22 are extracted in order, respectively, at the extraction of sector data in step S402, it is apparent that the same effect can be achieved even by the extraction in other orders. In addition, also in step S404, regardless of the extracting order the sector data, the same effect can be achieved at the end.

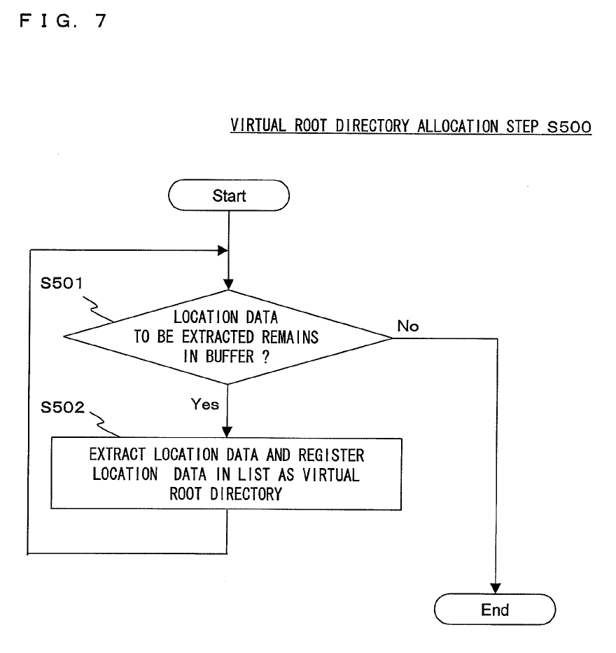

FIG. 7 illustrates the virtual root directory allocation step S500 in detail. In the virtual root directory allocation step S500, the virtual root directory allocation section 1224 registers the directory structure that the directory location determination section 1223 has stored as the location data in the directory location determination step S400 in a list as a virtual root directory.

In step S501, the virtual root directory allocation section 1224 determines whether or not the location data to be extracted remains in the buffer. When the location data to be read does not remain in the buffer (No in step S501), the process step of the virtual root directory allocation step S500 is terminated. When the location data to be extracted remains in the buffer (Yes in step S501), a process step of step S502 described below is performed.

In step S502, the virtual root directory allocation section 1224 extracts the location data stored in the buffer, and registers the location data in the list as a virtual root directory. Then, the processing returns to step S501 so as to process the subsequent location data.

As described above, in the virtual root directory allocation step S500, the virtual root directory allocation section 1224 registers all of the directory structures that the directory location determination section 1223 has stored as the location data in the directory location determination step S400 in the list as virtual root directories. Here, the directory structures of the directories 1 and 22 are registered in the list as the virtual root directories 1 and 2, respectively.

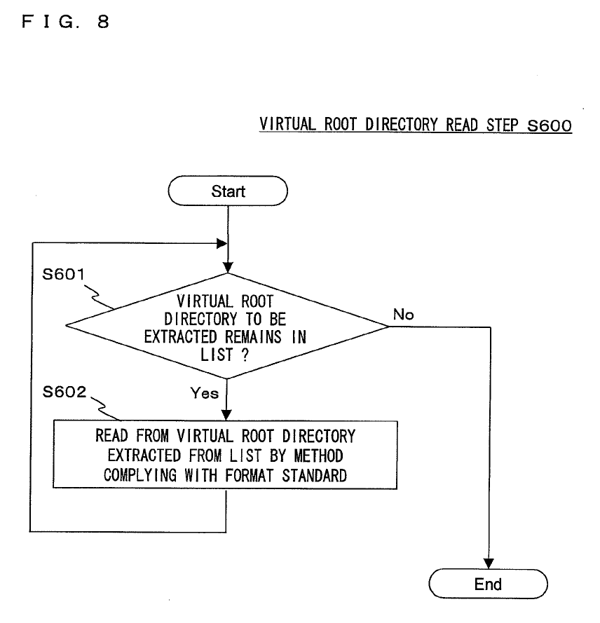

FIG. 8 illustrates the virtual root directory read step S600 in detail. In the virtual root directory read step S600, the reproduction section 123 reproduces, based on the virtual root directory that the virtual root directory allocation section 1224 has registered in the list in the directory location determination step S500, the recorded data in the method complying with the format standard.

In step S601, the reproduction section 123 determines whether or not a virtual root directory to be extracted remains in the list. When the virtual root directory to be extracted does not remain in the list (No in step S601), the process step of the virtual root directory read step S600 is terminated. When the virtual root directory to be extracted remains in the list (Yes in step S601), a process step of step S602 described below is performed.

In step S602, the reproduction section 123 extracts the virtual root directory in the list, and reproduces the recorded data in the method complying with the format standard, based on the extracted virtual root directory. Then, the processing returns to step S601 so as to process the subsequent virtual root directory. Here, since the directories 1 and 22 are registered in the list as the virtual root directories, the directory 11 and the files 12, 13, 111, and 112 under the directory 1 are reproduced, and further the files 221 and 222 under the directory 22 are reproduced.

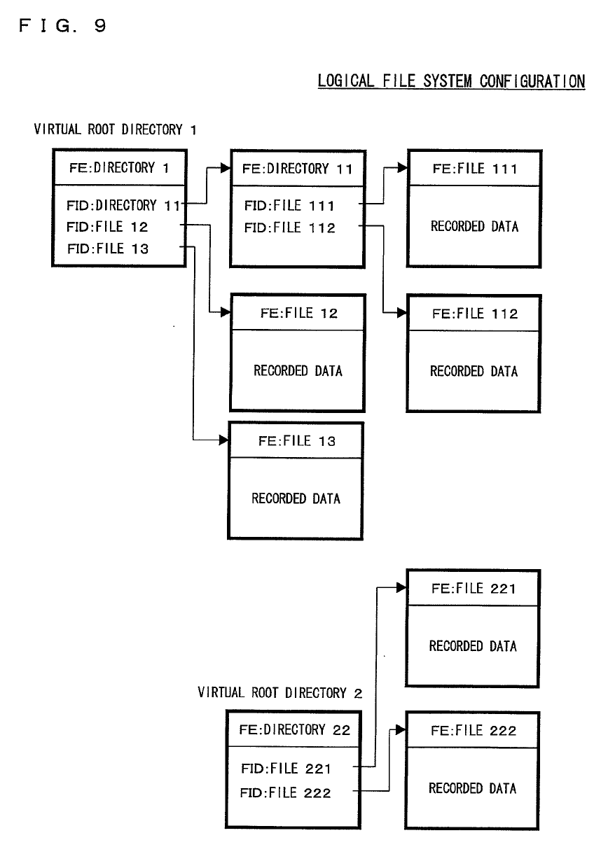

FIG. 9 illustrates a case where the directories 1 and 22 are set as the virtual root directories 1 and 2, respectively, and directories and files under the virtual root directories are reproduced. In a logical file system such as a UDF, generally, by using an FID and an FE as pointers, the FID, the FE and actual data under the root directory are accessed in order, respectively, based on the root directory. In the present embodiment, the directories 1 and 22 are set as the virtual root directories 1 and 2, respectively, and by using the FID and the FE as pointers, the FID, the FE and actual data under the virtual root directory are accessed in order, respectively, based on the virtual root directory.

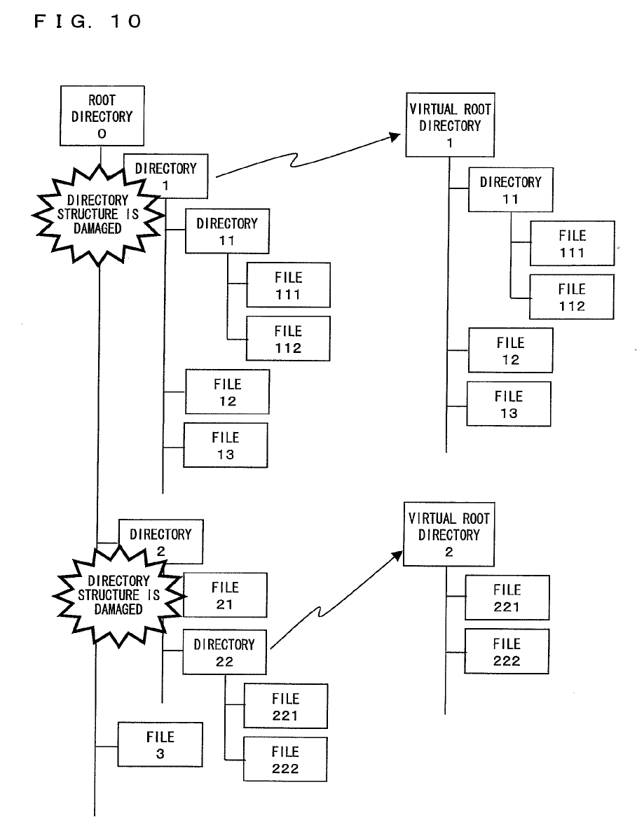

The display section 140 displays a directory and a file reproduced in the above-described method. FIG. 10 illustrates the directories and files that are displayed in the information reproduction method according to the present embodiment. In the logical file system, when the directory structure is damaged, all of the directories and files cannot be reproduced in the method complying with the format standard. However, as shown in FIG. 10, in the information reproduction method according to the present embodiment, by setting the directory 1 as the virtual root directory 1, the directory 1 and the files 12, 13, 111, and 112 under the virtual root directory 1 can be reproduced. Similarly, by setting the directory 22 as the virtual root directory 2, the files 221 and 222 under the virtual root directory 2 can be reproduced.

As described above, in the information reproduction method of the present invention, even when the directory management information is broken, the recorded data remaining in the disk medium is read, and the highest-order directory is set as the virtual root directory among directories at which the directory structure is not damaged, whereby the recorded data remaining in the disk medium can be reproduced.

Further, although in the present embodiment all of the directories and files under the virtual root directory can be reproduced, even when the directory structure under the virtual root directory is partially damaged, directories and files at which the directory structure is not damaged can be reproduced. For example, when the directory 11 under the virtual root directory 1 is damaged, the FID of the directory 11 is deleted from the FE of the directory 1 that is the virtual root directory 1. Thus, the files 12 and 13 under the directory 1 can be reproduced.

Still further, although in the present embodiment all of the recorded data remaining in the disk medium are extracted as sector data to be processed in the information reproduction, all of the recorded data may not necessarily be processed in the information reproduction depending on the situation. For example, when the location of recorded data on the disk medium, which is desired by a user to reproduce, can be identified, data may be extracted as sector data by setting only the storage location including nearby areas of the recorded data that is desired by the user to reproduce as a processing target of the information reproduction. Thus, the information reproduction of the recorded data that is desired by the user can be efficiently performed.

Still further, although the disk medium is used for the storage medium in the present embodiment, the present invention is not limited thereto and it is apparent that other storage media can achieve the same effect in a case where directory management information is broken.

### INDUSTRIAL APPLICABILITY

The information reproduction method of the present invention is applicable to an application for a personal computer, to a DVD recorder, to a digital video camera, to a digital still camera, and the like.

1. An information reproduction method for reproducing data which is recorded on an information storage medium based on a logical file system where a directory structure is constructed by using logical addresses and a storage location of the data is indicated based on a root directory, wherein the information reproduction method executes:
in the case where the recorded data becomes unable to be reproduced in a method based on the logical file system,
a virtual root directory creation step of reading the recorded data by using a physical address, extracting, based on information related to the directory structure and included in the read data, every directory whose higher-order directory is not found, and setting all of the extracted directory as the root directory; and
a reproduction step of reproducing, in the method based on the logical file system, a file under the virtual root directory based on the virtual root directory.

2. The information reproduction method according to claim 1, wherein the virtual root directory creation step executes:
a read-in-units step of reading data recorded on the information storage medium from which the recorded data has become unable to be reproduced in the method based on the logical file system, in units of a plurality of sectors as sector data;
a directory structure determination step of determining whether or not a plurality of pieces of the sector data read in the read-in-units step are information related to the directory structure;
a directory location determination step of determining a hierarchy and positional relation of a directory among directories based on at least one piece of the sector data which is determined in the directory structure determination step as the information related to the directory structure; and
a virtual root directory allocation step of allocating, as the virtual root directory, the directory which is determined in the directory location determination step as the directory whose higher-order directory is not found.

3. The information reproduction method according to claim 2, further executes a reproduction start determination step of determining whether or not to perform the information reproduction method in accordance with an input by one of a user and settings.

4. An information reproduction apparatus for reproducing data which is recorded on an information storage medium based on a logical file system where a directory structure is constructed by using logical addresses and a storage location of the data is indicated based on a root directory, the information reproduction apparatus comprising:
a virtual root directory creation section for reading, in the case where the recorded data becomes unable to be reproduced in a method based on the logical file system, the recorded data by using a physical address, extracting, based on information related to the directory structure and included in the read data, every directory whose higher-order directory is not found, and setting all of the extracted directory as the root directory; and
a reproduction section for reproducing, in the case where the recorded data becomes unable to be reproduced in a method based on the logical file system, a file under the virtual root directory based on the virtual root directory, in the method based on the logical file system.

5. The information reproduction apparatus according to claim 4, wherein the virtual root directory creation section includes:
a read-in-units section for reading data recorded on the information storage medium from which the recorded data has become unable to be reproduced in the method based on the logical file system, in units of a plurality of sectors as sector data;
a directory structure determination section for determining whether or not a plurality of pieces of the sector data read by the read-in-units section are information related to the directory structure;
a directory location determination section for determining a hierarchy and positional relation of a directory among directories based on at least one piece of the sector data which is determined by the directory structure determination section as the information related to the directory structure; and
a virtual root directory allocation section for allocating, as the virtual root directory, the directory, which is determined by the directory location determination section as the directory whose higher-order directory is not found.

6. The information reproduction apparatus according to claim 5, further comprising a reproduction start determination section for determining whether or not to perform the information reproduction method in accordance with an input by one of a user and settings.

7. An information reproduction program for reproducing data which is recorded on an information storage medium based on a logical file system where a directory structure is constructed by using logical addresses and a storage location of the data is indicated based on a root directory, wherein the information reproduction program executes:
in the case where the recorded data becomes unable to be reproduced in a method based on the logical file system,
a virtual root directory creation step of reading the recorded data by using a physical address, extracting, based on information related to the directory structure and included in the read data, every directory whose higher-order directory is not found, and setting all of the extracted directory as the root directory; and
a reproduction step of reproducing, in the method based on the logical file system, a file under the virtual root directory based on the virtual root directory.

8. A storage medium on which is recorded an information reproduction program for reproducing data which is recorded on an information storage medium based on a logical file system where a directory structure is constructed by using logical addresses and a storage location of the data is indicated based on a root directory, wherein the information reproduction program executes:
in the case where the recorded data becomes unable to be reproduced in a method based on the logical file system,
a virtual root directory creation step of reading the recorded data by using a physical address, extracting, based on information related to the directory structure and included in the read data, every directory whose higher-order directory is not found, and setting all of the extracted directory as the root directory; and
a reproduction step of reproducing, in the method based on the logical file system, a file under the virtual root directory based on the virtual root directory.
